(19) United States
(12) Patent Application Publication
(10) Pub. No.: US 2004/0082720 A1
(43) Pub. Date: Apr. 29, 2004

(54) Adducts of amine-terminated polyolefins and epoxides

(75) Inventor: Robert J. Letchford, Cherryville, NC (US)

Correspondence Address: MYERS BIGEL SIBLEY & SAJOVEC, PO BOX 37428, RALEIGH, NC, 27627, US

(73) Assignee: FMC Corporation

(21) Appl. No.: 09/908,441

(22) Filed: Jul. 18, 2001

Related U.S. Application Data
(60) Provisional application No. 60/218,912, filed on Jul. 18, 2000.

(51) Int. Cl. C08L 47/00

(52) U.S. Cl. 525/122

(57) ABSTRACT

Adducts of epoxides and amine terminated polyolefins are provided. The adducts can be chain extended with suitable polyfunctional agents to increase solubility. The resultant adducts are useful in a variety of applications including sealants, coatings, adhesives, composites, and the like.

### CROSS-REFERENCE TO RELATED APPLICATIONS

This application is related to copending provisional Application Serial No. 60/218,912, filed Jul. 18, 2000, the entire disclosure of which is hereby incorporated by reference, and claims the benefit of its earlier filing date under 35 USC 119(e).

### FIELD OF THE INVENTION

The present invention relates to adducts of amine terminated polyolefins and epoxides and methods of making and using the same.

### BACKGROUND OF THE INVENTION

Epoxy resins are thermosetting resins based on the reactivity of an epoxide group:

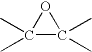

High resistance to chemicals and outstanding adhesion, durability, and toughness have made them valuable as coatings. Because of their high electrical resistance, durability at high and low temperatures, and the ease with which they can be poured or cast without forming bubbles, epoxy resins are especially useful for encapsulating electrical and electronic components. Epoxy resin adhesives can be used on metals, construction materials, and most other synthetic resins.

Despite these and other desirable properties, unmodified epoxies are typically brittle. More flexible grades of epoxy resins can be produced by incorporating other organic moieties into the polymer to modify the epoxy resin structure.

For example, carboxyl functionalities have been incorporated into polyolefins for use in epoxy coatings and adhesives in an attempt to improve flexibility and adhesion, among other properties. As discussed in U.S. Pat. No. 4,088,708, such carboxyl terminated polymers have carbon-carbon backbone linkages derived from polymerization of at least one vinylidene monomer having at least one terminal CH₂═C< group, such as that selected from monoolefins, dienes, and acrylates. Especially useful are carboxyl-terminated copolymers of butadiene and acrylonitrile, referred to in the art as “CTBN” polymers. Typically the carboxyl functional polymers are blended and reacted with polyepoxides to form the desired epoxy resin. See also U.S. Pat. No. 3,823,107.

While such resins can have good properties, carboxyl functionalized polymers are not always useful for every application. Accordingly amine terminated polymers have been developed that are derived from the CTBN polymers described above. For example, amine terminated polymers derived from a CTBN polymer are generally referred to in the art as “ATBN” resins. ATBNs can be prepared as described in U.S. Pat. No. 4,088,708, referenced above, for example by reacting the carboxy functional polymer with a suitable amine, typically a primary amine. The resultant amine terminated polymer includes a carbonyl functionality adjacent the terminal amine group.

There are, however, problems associated with ATBNs as well. The amine terminated polymers typically are not stable in the presence of epoxides, and the viscosity of the mixture can rapidly and dramatically increase. Thus epoxide/ATBN compositions generally exhibit short shelf lives. Although not wishing to be bound by any explanation of this phenomenon, the applicants currently believe that this instability is due to residual primary amines present in the ATBN polymer composition. The primary amines have an additional reactive hydrogen that can react with the epoxy resin and cross link the same. In addition, both CTBN and ATBN polymers can exhibit relatively poor thermal oxidative stability, which limits their use in many applications such as surface coatings.

### SUMMARY OF THE INVENTION

The present invention is directed to unique compounds having various desirable yet contradictory properties. In particular the invention provides adducts of epoxy resins and amine terminated polyolefins. The adducts of the invention exhibit toughness, chemical resistance and other desired properties imparted thereto by the epoxy component. Yet the adducts also exhibit improved flexibility and impact resistance, due to the incorporation of the polyolefinic backbone into the epoxy adduct. Thus the adducts can be used in a variety of applications, including without limitation coatings, sealants, adhesives, and composites (prepregs).

The epoxy resins can be any suitable epoxide having two or more epoxy functionalities and capable of reacting with the amine-terminated polyolefins. While any diepoxide can be used, one currently preferred diepoxide resin is the diglycidyl ether of Bisphenol A (DGEBA). However, cycloaliphatic epoxies can also be used as well to impart improved thermal oxidative and UV stability.

The amine terminated polyolefins are advantageously prepared via anionic polymerization using lithium initiators, including dilithium initiators and functionalized lithium initiators having a protected amine functionality as known in the art. The resulting living chain end can be functionalized using amine electrophiles. Amine protecting groups, when present, are removed to liberate the amine functionalities.

The amine terminated polyolefins are preferably substantially hydrogenated, so that at least about 70%, or more, of the carbon-carbon double bonds are saturated. The inventors have found that the use of hydrogenated amine functionalized polyolefins can provide the benefit of improved thermal oxidative stability and UV stability as compared to epoxy adducts having unsaturated polyolefin backbones. Further, the presence of the polyolefin chain can provide other useful properties to the resulting adducts, such as elastomeric properties and improved adhesion of the adducts to polyolefin substrates.

The resulting adducts can be generally represented by the formula:

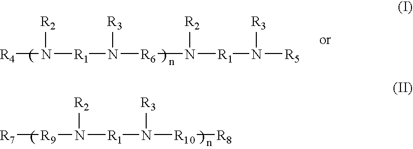

wherein:

R₁ is a polyolefin;

R₂ and R₃ are independently H or substituted or unsubstituted C1-C25 alkyl;

R₄ and R₅ are independently H or substituted or unsubstituted C1-C25 alkyl;

R₆ is a hydroxy containing moiety formed by the reaction of an epoxide with a primary or secondary amine-containing compound R₂—NH—R₁—NH—R₃ thereby opening the epoxide rings;

R₇ and R₈ are independently epoxide containing moieties;

R₉ and R₁₀ are independently hydroxy containing moieties formed by the reaction of an epoxide with a primary or secondary amine-containing compound R₂—NH—R₁—NH—R₃ thereby opening the epoxide ring; and

n is a number from 1 to 10, and preferably 1 to 5.

Particularly preferred adducts include compounds of the formula III:

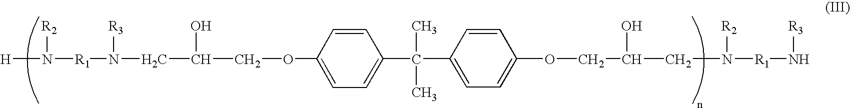

wherein R₁ is a polyolefin selected from the group consisting of hydrogenated polybutadienes, hydrogenated isoprenes, and hydrogenated copolymers of butadiene and isoprene; R₁ is derived from an amine terminated polyolefin having a molecular weight of from about 1000 to about 200,000; and n is 1 or 2.

Other preferred adducts of the invention include compounds of the formula IV:

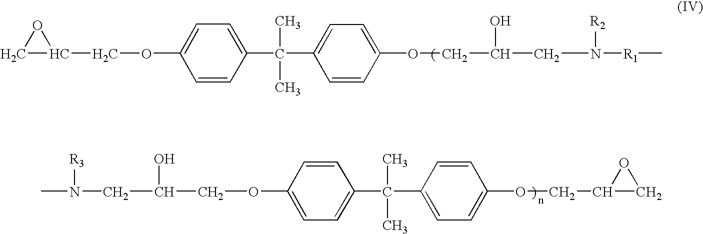

wherein R₁ is a polyolefin selected from the group consisting of hydrogenated polybutadienes, hydrogenated isoprenes, and hydrogenated copolymers of butadiene and isoprene; R₁ is derived from an amine terminated polyolefin having a molecular weight of from about 1000 to about 200,000; and n is 1 or 2.

The present invention also provides methods for making the adducts of the invention. Generally the adducts can be prepared by reacting an epoxy resin having an epoxide functionality of at least about 2 with an amine terminated polyolefin. The amine terminated polyolefin includes compounds having the formula:

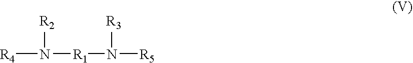

wherein:

R₁ is a polyolefin;

R₂ and R₃ are independently H or substituted or unsubstituted C1-C25 alkyl; and

R₄ and R₅ are independently H or substituted or unsubstituted C1-C25 alkyl. The reaction can take place at temperatures ranging from about 0 to about 150° C. for at least about 0.5 hour, and up to 8 hours, although temperature and reaction times outside of these ranges can be employed as well. The reaction can be conducted with an excess amount of the amine-terminated polyolefin or an excess amount of the epoxy resin.

The present invention also includes methods of chain extending or “advancing” the adducts of the invention to increase solubility of the adducts. In this aspect of the invention the adducts are further reacted with a polyfunctional compound, such as polyols and/or additional diepoxides.

Such chain extended adducts include compounds of the formula

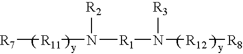

wherein:

R₁ is a polyolefin;

R₂ and R₃ are independently H or substituted or unsubstituted C1-C25 alkyl;

R₇ and R₈ are independently epoxide containing moieties;

R₁₁ and R₁₂ are independently hydroxy containing moieties formed by the reaction of the adduct of formula II with at least one polyfunctional compound selected from the group consisting of polyols, polyepoxides, and mixtures thereof; and

each y is independently 2 to 50. Currently preferred chain extended adducts include compounds of this formula in which each R₁₁ and R₁₂ are

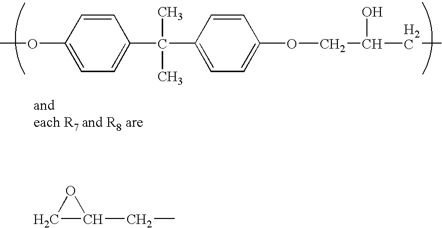

### DETAILED DESCRIPTION OF THE INVENTION

The present invention now will be described more fully hereinafter, in which preferred embodiments of the invention are described. This invention may, however, be embodied in many different forms and should not be construed as limited to the embodiments set forth herein; rather, these embodiments are provided so that this disclosure will be thorough and complete, and will fully convey the scope of the invention to those skilled in the art.

The amine-terminated polyolefins are prepared by methods known to those skilled in the art such as those described in U.S. Pat. No. 5,965,681 to Schwindeman et al.; U.S. Pat. No. 5,910,547 to Schwindeman et al.; U.S. Pat. No. 6,197,891 to Schwindeman et al.; and U.S. patent application Ser. No. 09/256,737, filed Feb. 24, 1999, to Schwindeman et al, now U.S. Pat. No. 6,121,474, issued Sep. 19, 2000, which are all incorporated herein by reference in their entirety. See also U.S. patent application Ser. No. 09/665,528, filed Sep. 19, 2000, to Brockmann et al., which is also incorporated herein by reference in its entirety.

For example, a protected amine functional lithium anionic polymerization initiator, such as described in the above-referenced patents, may be used to polymerize one or more suitable monomer(s) capable of anionic polymerization, including conjugated alkadienes, alkenylsubstituted aromatic hydrocarbons, and mixtures thereof. An exemplary protected amine functionalized initiator has the formula:

M-Qₙ-Z-N-(A-R¹R²R³)₂

wherein:

M is an alkali metal selected from the group consisting of lithium, sodium and potassium;

Z is a branched or straight chain hydrocarbon connecting group which contains 3-25 carbon atoms optionally substituted with aryl or substituted aryl containing lower alkyl, lower alkylthio, or lower dialkylamino groups;

Q is a saturated or unsaturated hydrocarbyl group derived by incorporation of one or more conjugated diene hydrocarbons, one or more alkenylsubstituted aromatic hydrocarbons, or mixtures thereof;

n is a number from 0 to 5, and

(A-R¹R²R³)₂ is a protecting group in which A is an element selected from Group IVa of the Periodic Table of the Elements; and R¹, R², and R³ are independently selected from the group consisting of hydrogen, alkyl, substituted alkyl, aryl, substituted aryl, cycloalkyl, and substituted cycloalkyl, or R³ is optionally a —(CR⁷R⁸)₁— group linking two As wherein R⁷ and R⁸ are each independently selected from the group consisting of hydrogen, alkyl, substituted alkyl, aryl, substituted aryl, cycloalkyl, and substituted cycloalkyl, and 1 is an integer from 1 to 7. Thus the skilled artisan will appreciate that R³ as used herein includes the group

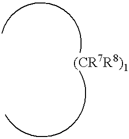

linking two A groups.

Unless otherwise indicated, as used herein, the term “alkyl” refers to straight chain and branched C1-C25 alkyl. The term “substituted alkyl” refers to C1-C25 alkyl substituted with one or more lower C1-C10 alkyl, lower alkoxy, lower alkylthio, or lower dialkylamino. The term “cycloalkyl” refers to C3-C12 cycloalkyl. The term “substituted cycloalkyl” refers to C3-C12 cycloalkyl substituted with one or more lower C1-C10 alkyl, lower alkoxy, lower alkylthio, or lower dialkylamino. The term “aryl” refers to C5-C25 aryl having one or more aromatic rings, each of 5 or 6 carbon atoms. Multiple aryl rings may be fused, as in naphthyl or unfused, as in biphenyl. The term “substituted aryl” refers to C5-C25 aryl substituted with one or more lower C1-C10 alkyl, lower alkoxy, lower alkylthio, or lower dialkylamino. Exemplary aryl and substituted aryl groups include, for example, phenyl, benzyl, and the like.

The resultant living polymer will include a protected amine functional group at one terminus and a living chain end at the other terminus. The living chain end may then be functionalized with an amine functional electrophile. Exemplary amine functional electrophiles include without limitation those described in the aforementioned references, as well as other amine electrophiles as known in the art suitable for providing an amine functionality to an living polymer chain end. Such functionalizing agents can have the following structure:

X—Y—N—(B—R⁴R⁵R⁶)₂

wherein:

X is halogen, preferably chloride, bromide or iodide;

Y is branched or straight chain hydrocarbon connecting groups which contains 1-25 carbon atoms optionally substituted with aryl or substituted aryl containing lower alkyl, lower alkylthio, or lower dialkylamino groups;

(B—R⁴R⁵R⁶)₂ is a protecting group in which B is an element selected from Group IVa of the Periodic Table of the Elements; and R⁴, R⁵ and R⁶ are independently selected from the group consisting of hydrogen, alkyl, substituted alkyl, aryl, substituted aryl, cycloalkyl, and substituted cycloalkyl or R⁶ is optionally a —(CR⁷R⁸)₁— group linking two Bs wherein R⁷ and R⁸ are each independently selected from the group consisting of hydrogen, alkyl, substituted alkyl, aryl, substituted aryl, cycloalkyl, and substituted cycloalkyl, and 1 is an integer from 1 to 7. Thus the skilled artisan will appreciate that R⁶ as used herein includes the group

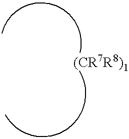

linking two B groups.

The protecting groups, when present, can be removed using techniques known in the art, also as described in the aforementioned references. Residual carbon-carbon double bonds can be hydrogenated until at least 70% or more of the aliphatic unsaturation has been saturated.

Alternatively the amine terminated polymers may be prepared using a dilithium initiator such as described in U.S. Pat. No. 5,965,681, referenced above. For example, such polymers can be prepared by adding two (2) equivalents of at least one lithium initiator or a mixture of lithium initiators, such as sec-butyllithium, to at least one or a mixture of compounds having at least two independently polymerizable vinyl groups, such as 1,3-divinylbenzene or 1,3-diisopropenylbenzene, to form a dilithium initiator having a central core formed of the compounds(s) having polymerizable vinyl groups. Thereafter at least one monomer selected from the group consisting of conjugated dienes, alkenylsubstituted aromatic hydrocarbons, and mixtures thereof, is added to grow or polymerize polymer arms having living ends from the central core. The living chain ends are functionalized by adding two equivalents of at least one or a mixture of functionalizing agents (electrophiles), which can have the following structure:

X—Y—N—(B—R⁴R⁵R⁶)₂

wherein X, Y, B, R⁴, R⁵, and R⁶ are as defined above.

Examples of suitable conjugated alkadienes include, but are not limited to, 1,3-butadiene, isoprene, 2,3-dimethyl-1,3-butadiene, 1,3-pentadiene, myrcene, 2-methyl-3-ethyl-1,3-butadiene, 2-methyl-3-ethyl-1,3-pentadiene, 1,3-hexadiene, 2-methyl-1,3-hexadiene, 1,3-heptadiene, 3-methyl-1,3-heptadiene, 1,3-octadiene, 3-butyl-1,3-octadiene, 3,4-dimethyl-1,3-hexadiene, 3-n-propyl-1,3-pentadiene, 4,5-diethyl-1,3-octadiene, 2,4-diethyl-1,3-butadiene, 2,3-di-n-propyl-1,3-butadiene, 2-methyl-3-isopropyl-1,3-butadiene and mixtures thereof.

Examples of polymerizable alkenylsubstituted aromatic hydrocarbons include, but are not limited to, styrene, alpha-methylstyrene, vinyltoluene, 2-vinylpyridine, 4-vinylpyridine, 1-vinylnaphthalene, 2-vinylnaphthalene, 1-alpha-methylvinylnaphthalene, 2-alpha-methylvinylnaphthalene, 1,2-diphenyl-4-methyl-1-hexene and mixtures of these, as well as alkyl, cycloalkyl, aryl, alkylaryl and arylalkyl derivatives thereof in which the total number of carbon atoms in the combined hydrocarbon constituents is generally not greater than 18. Examples of these latter compounds include 3-methylstyrene, 3,5-diethylstyrene, 4-tert-butylstyrene, 2-ethyl-4-benzylstyrene, 4-phenylstyrene, 4-p-tolylstyrene, 2,4-divinyltoluene and 4,5-dimethyl-1-vinylnaphthalene. U.S. Pat. No. 3,377,404, incorporated herein by reference in its entirety, discloses suitable additional alkenylsubstituted aromatic compounds.

Examples of methods to hydrogenate the polymers of this invention are described in Falk, Journal of Polymer Science: Part A-1, vol. 9, 2617-2623 (1971), Falk, Die Angewandte Chemie, 21, 17-23 (1972), U.S. Pat. Nos. 4,970,254, 5,166,277, 5,393,843, 5,496,898, and 5,717,035. The hydrogenation of the functionalized polymer is conducted in situ, or in a suitable solvent, such as hexane, cyclohexane or heptane. This solution is contacted with hydrogen gas in the presence of a catalyst, such as a nickel catalyst. The hydrogenation is typically performed at temperatures from 25° C. to 150° C., with a archetypal hydrogen pressure of 15 psig to 1000 psig. The progress of this hydrogenation can be monitored by InfraRed (IR) spectroscopy or Nuclear Magnetic Resonance (NMR) spectroscopy. The hydrogenation reaction is conducted until at least 70% of the aliphatic unsaturation has been saturated. The hydrogenated functional polymer is then recovered by conventional procedures, such as removal of the catalyst with aqueous acid wash, followed by solvent removal or precipitation of the polymer.

The polymerization is preferably conducted in a non-polar solvent such as a hydrocarbon, since anionic polymerization in the presence of such non-polar solvents is known to produce polyenes with high 1,4-contents from 1,3-dienes. Inert hydrocarbon solvents useful in practicing this invention include but are not limited to inert liquid alkanes, cycloalkanes and aromatic solvents and mixtures thereof. Exemplary alkanes and cycloalkanes include those containing five to 10 carbon atoms, such as pentane, hexane, cyclohexane, methylcyclohexane, heptane, methylcycloheptane, octane, decane and the like and mixtures thereof. Exemplary aryl solvents include those containing six to ten carbon atoms, such as toluene, ethylbenzene, p-xylene, m-xylene, o-xylene, n-propylbenzene, isopropylbenzene, n-butylbenzene, and the like and mixtures thereof.

Polar solvents (modifiers) can be added to the polymerization reaction to alter the microstructure of the resulting polymer, i.e., increase the proportion of 1,2 (vinyl) microstructure or to promote functionalization or randomization. Examples of polar modifiers include, but are not limited to: diethyl ether, dibutyl ether, tetrahydrofuran (THF), 2-methyltetrahydrofuran, methyl tert-butyl ether (MTBE), diazabicyclo[2.2.2] octane (DAB CO), triethylamine, tri-n-butylamine, N,N,N′,N′-tetramethylethylenediamine (TMEDA), and 1,2-dimethoxyethane (glyme). The amount of the polar modifier added depends on the vinyl content desired, the nature of the monomer, the temperature of the polymerization, and the identity of the polar modifier.

The resultant amine terminated polyolefin can be generally represented by the formula

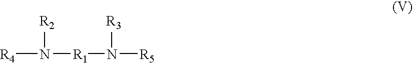

wherein R₁ is a polyolefin, and R₂, R₃, R₄, and R₅ are independently H or substituted or unsubstituted C1-C25 alkyl. Preferably R₂ and R₄ are not both hydrogen and R₃ and R₅ are not both hydrogen. The amine function of the amine terminated polyolefins used to produce the adducts of the invention is preferably secondary because primary amines have an additional reactive hydrogen that can react with the polyfunctional acrylate and cross link the same.

The telechelic amine functional polymer is preferably a hydrogenated polybutadiene, a hydrogenated polyisoprene, or a hydrogenated copolymer of butadiene and isoprene. Preferably, at least about 70%, more preferably at least about 90%, and most preferably up to about 98% of the unsaturated carbon-carbon double bonds in the polymers or copolymers are hydrogenated.

The molecular weight of the amine functional polymer can range from about 1000 to about 200,000, preferably from about 1500 to about 20,000 and more preferably from about 3000 to about 5000. There should be sufficient pendent vinyl groups in the polybutadiene to prevent crystallization of the polymer upon hydrogenation. Preferably, the functionality of the amine terminated polyolefin is from about 1.5 to about 2.0 amine groups per chain.

The epoxy resins can be any suitable epoxide having two or more epoxy functionalities and capable of reacting with the amine-terminated polyolefins. Such epoxides are known in the art and are commercially available.

The amine functional polymers as prepared above are reacted with epoxy resins to give adducts as represented by the structures:

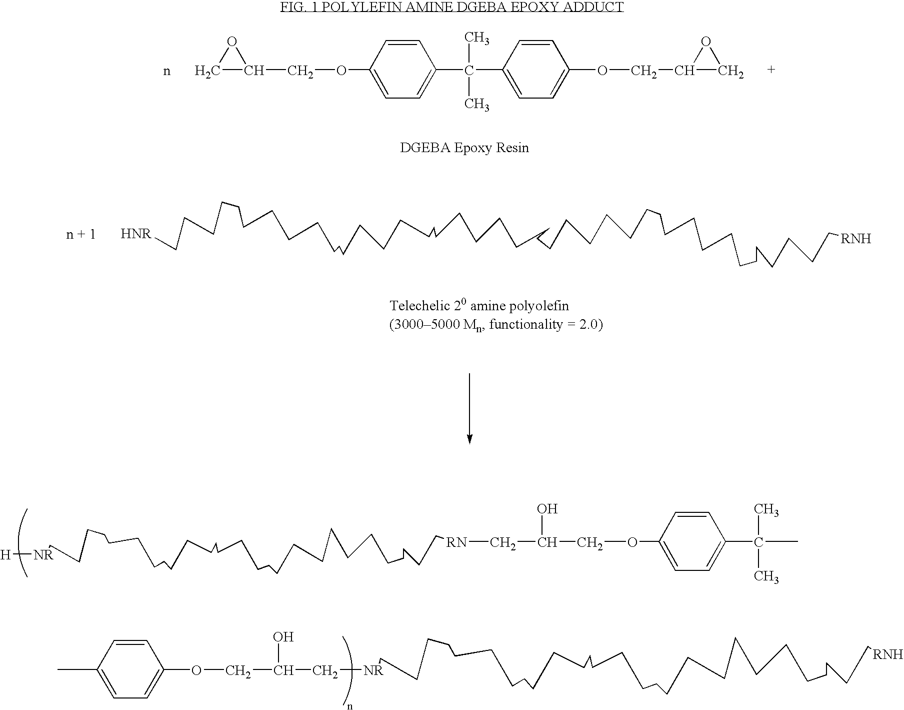

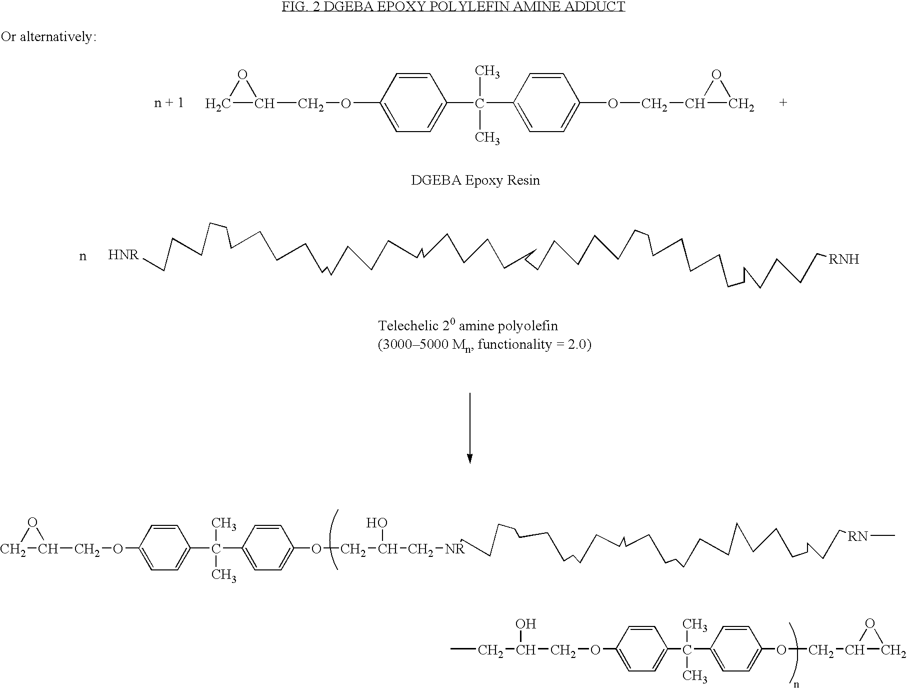

While any diepoxide can be used, the diepoxide resin generally employed for such adducts is the diglycidyl ether of Bisphenol A (DGEBA). Other aromatic epoxies can be used such as the diglycidyl ether of Bisphenol F, or the diglycidyl ether of resorcinol. For improved thermal oxidative and UV stability, it is preferred to use cycloaliphatic epoxies. To maintain fluidity in the adducts, n is preferably <=2.0. Furthermore, if fluidity is desired, a low viscosity liquid diepoxide, such as the difunctional novalac of Bisphenol F, can be used. In certain conditions, e.g., if n is higher than 2, it may be desirable to use diluents or solvents such as acetone, benzyl alcohol or other polar solvents, to produce the adducts of the invention. However, a large molar excess (up to 5×) of one reactant or the other allows the adducting to be done with ease. Similar schemes can employ tri- and tetra-functional epoxy resins but with adjusted stoichiometries.

For improved thermal oxidative and UV stability, cycloaliphatic epoxy resins can be used in the above adducts instead of DGEBA. Examples of cycloaliphatic epoxy resins are:

From Resolution Performance Products

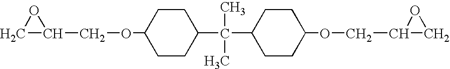

2,2-Bis-(4-glycidyloxycyclohexyl)propane (Hydrogenated DGEBA Epoxy Resin)

From Dow/Union Carbide

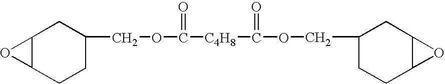

Bis(3,4-epoxy-6-methylcyclohexyl)adipate

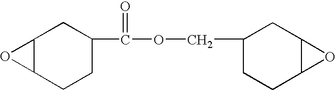

3,4 epoxycyclohexylmethyl-3,4-epoxy-cyclohexane-carboxylate

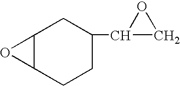

Vinyl Cyclohexane Dioxide

Other cycloaliphatic epoxy resins include without limitation 4-(1,2-epoxyethyl)-1,2-epoxycyclohexane, 1,2-8,9-diepoxy-p-menthane, 2,2-bis(3,4-epoxycyclohexyl)propane, 1,2-5,6-diepoxy-4,7-hexahydromethaneoindane, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, 3,4-epoxy-6-methylcyclohexylmethyl-4-epoxy-6-methylcyclohexane carboxylate, 2-(3,4-epoxy)cyclohexyl-5,5-spiro(3,4-epoxy)cyclohexane-m-dioxane, and the like.

Cycloaliphatic epoxy resins like vinyl cyclohexane dioxide, shown above, have epoxy groups of different reactivities, one cycloaliphatic and one non-cycloaliphatic, the amine being more reactive with the non-cycloaliphatic. By use of such an epoxy, coupling can be avoided and it is possible to make adducts where n=1 in FIGS. 1 and 2 above. Other cycloaliphatic epoxy resins with both cycloaliphatic and non-cycloaliphatic epoxy groups include without limitation 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, o-(2,3-epoxy)cyclopentylphenyl-2,3-epoxypropyl ether, and the like.

If both epoxy groups have equal reactivity with the amine terminated polymer, care must be taken to adjust the stoichiometry and reaction conditions to avoid too much coupling or chain extension, that is bring the value of n as close to 1.0 as possible, although for some applications, a higher value of n may be advantageous.

Preferably, the epoxy resins are low molecular weight liquid resins (e.g. having an epoxy equivalent weight of from 76 to 2000). However, for some applications, solid epoxy resins of higher various epoxy equivalent weights (EEWs) can also be used.

Catalysts, although not required to manufacture the adducts, can be used to facilitate reactions at lower temperatures, or even at room temperature. Suitable catalysts include tertiary nitrogen bases, salts, complexes, quaternaries or similar phosphine compounds.

The adducts of the invention can be used in coatings, sealants, adhesives, and composites (prepregs) and can be further combined with additives, stabilizers, pigments, and other ingredients for the desired end use application. However, the adducts of the invention may have limited solubility in standard epoxy formulations for adhesives, sealants, coatings and other applications due to the olefinic nature of the amine terminated polyolefin used therein. To increase the solubility and hence compatibility of such adducts, it is preferred to raise the polarity of the adducts by chain extension, often referred to as “advancement” in epoxy chemistry terminology.

This invention covers the advanced resins formed by reacting the adducts of FIG. 2 with polyols and/or additional diepoxides, as described below. As disucssed above with reference to FIG. 2, when a large stoichiometric excess of epoxy is used and the diamine functional polyolefin is added to the epoxy, the formation of the adduct as shown in FIG. 3 result. This adduct may then be chain extended or advanced, for example by addition of Bisphenol A as illustrated in FIG. 3 below, which upon heating with addition of a basic catalyst, will react with the epoxy termini of the adduct and with additional epoxy resin to produce an “advanced” resin.

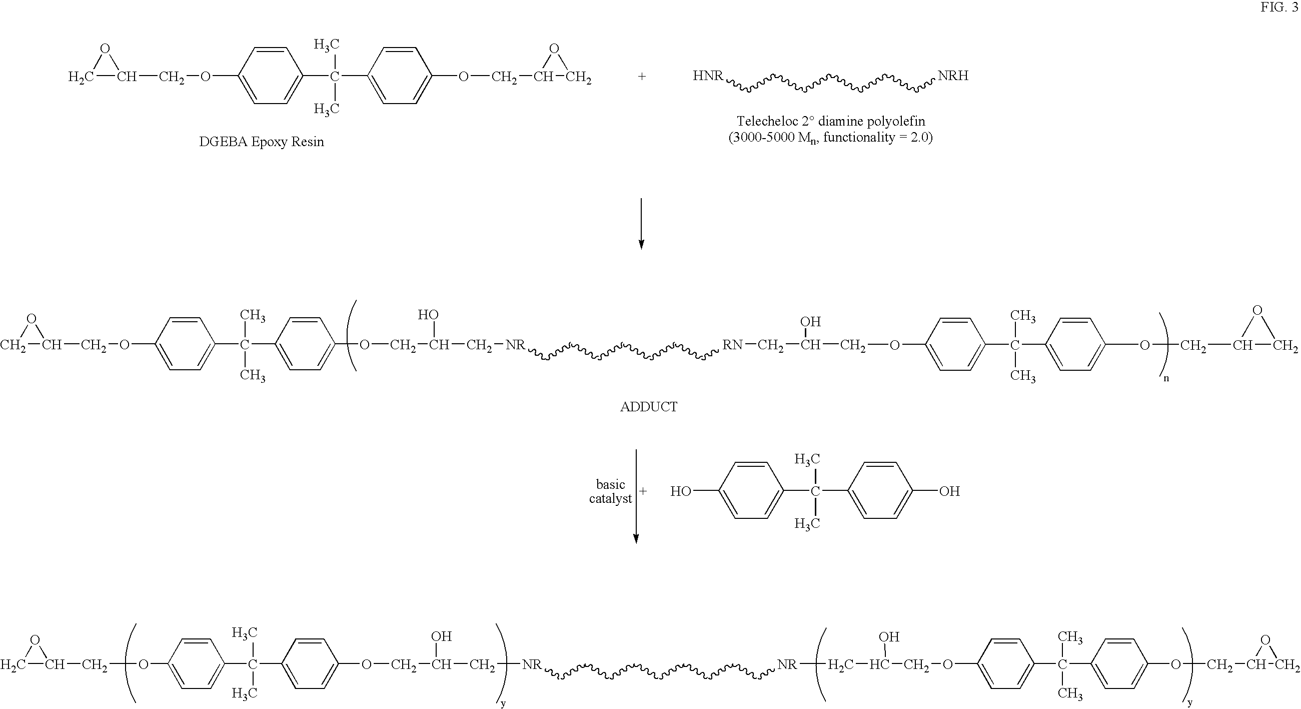

Thus the adducts of the invention as illustrated in FIG. 2 above can be chain extended or advanced by reacting the adducts with polyols and/or additional diepoxides, by methods known in the art, as described herein. These advanced adducts allow control over “critical molecular weight” (M), which has implications for toughening/flexibility enhancement, as well as system rheology.

In particular, the advancement of such adducts can be accomplished by reacting the adducts as described above with additional polyhydroxyl group materials and additional polyepoxides such as DGEBA, or other diepoxide compounds as discussed above. The polyhydroxy group materials include, but are not limited to, 1,2-propylene glycol, 1,4-propylene glycol, 1,5-pentanediol, 1,2,6-hexanetriol, glycerol, neopentyl glycol, bis(4-hydroxycyclohexyl)-2,2-propane, Bisphenol A or other polyhydroxy aromatic compounds such as resorcinol, 1,3,5-benzenetriol, 1-2-benzenediol, catechin, ethylene glycol, butylene glycol, 1,6-hexylene glycol, trimethylol propane, pentaerythritol, polyester polyols, polyether polyols, urethane polyols, and acrylic polyols. Other aromatic polyols include 4,4′-dihydroxybenzophenone, bis(4-hydroxyphenyl) 1,1-ethane, bis(4-hydroxyphenyl)1,1-isobutane, bis(4-hydroxyltertiarybutyl-phenyl-2,2-propane, bis(2-hydroxynaphthyl)methane, 1,5-dihydroxynaphthylene, or the like. Particularly attractive to high temperature performance are the diepoxides having biphenyl structure, those based on a fluorene diol, or those based on the liquid crystal α-methyl stilbene. Advancement or chain extension reactions of polyepoxides and polyhydroxy materials are described, e.g., in U.S. Pat. Nos. 3,922,253; 4,001,156; 4,031,050; 4,148,772; 4,468,307; 4,711,917; 4,931,157; and 6,084,036.

Chain extension or advancement can also be carried out by reacting the adducts with polycarboxylic acids in addition to the polyepoxides and/or polyols discussed above. Suitable polycarboxylic acids include, but are not limited to, oxalic acid, succinic acid, glutaric acid, terephthalic acid, 2,6-naphthalene dicarboxylic acid, dimerized linolenic acid, adipic acid, 3,3-dimethylpentanedioic acid, isophthalic acid, phthalic acid, phenylenediethanoic acid, pimelic acid, suberic acid, azelaic acid, sebacic acid, maleic acid, fumaric acid, tetrahydrophthalic acid, hexahydrophthalic acid, and trimellitic acid, and the like (see Epoxy Resins, Chemistry and Technology, Marcel Dekker, 2nd edition (1988), p. 757).

Catalysts, although not required for the chain extension of the adducts of the invention, can be used to facilitate reactions at room temperature or higher temperatures, if desired. Suitable catalysts include tertiary nitrogen bases, salts, complexes, quaternaries or similar phosphine compounds.

The following non-limiting examples illustrate the present invention.

### EXAMPLE 1

### Preparation of Di-Amine Functional Polyolefin Epoxy Adduct (Resin A)

A di-amine functional polyolefin epoxy adduct (Resin A) is prepared using the following:

| Ingredients | Parts by Weight (grams) |
|---|---|
| EPON 2004¹ | 5000 |
| DSA-PEB-50² | 1900 |
| ¹Polyglycidyl ether of Bisphenol A having an epoxy equivalent weight of 875 to 975, commercially available from Resolution Performance Products, Houston, TX. | |
| ²Di-sec-amine functional poly-ethylene-butylene, with a number average molecular weight of 3500, prepared as described in the specification from the polymerization of butadiene, using a protected secondary amine functional lithium initiator, followed by reaction with a | |
| # sec-amine funcitonal electrophile and then hydrogenation. The polymer butylene content is preferably in the range of 30-70%, but the range could be 10-90% of butylene content in the microstructure. The polymer has an amine functionality of about 1.9. | |

The DSA-PEB-50 di-sec-amine functional polyolefin and EPON 2004 are added to a suitable reaction vessel, under a nitrogen atmosphere, with stirring, and the mixture is gradually heated to 800° C. The reaction mixture is maintained at this temperature for 3 hours. The resultant polyolefin modified epoxy adduct has an epoxide equivalent weight of about 1600.

### EXAMPLE 2

### Preparation of Di-Amine Functional Polyolefin Epoxy Adduct Chain Extended with Bisphenol A (Resin B)

A di-amine functional polyolefin epoxy adduct chain extended with bisphenol A is prepared using the following:

| Ingredients | Parts by Weight (grams) |
|---|---|
| PART A | |
| EPON 828¹ | 2900 |
| DSA-PEB-50² | 1000 |
| PART B | |
| Bisphenol A | 1200 |
| ethyl triphenyl phosphonium iodide | 2.0 |
| ¹Diglycidyl ether of Bisphenol A having an epoxy equivalent weight of 185-192, commercially available from Resolution Performance Products, Houston, TX. | |
| ²Di-sec-amine functional poly-ethylene-butylene, with a number average molecular weight of 3500, prepared as described in the specification from the polymerization of butadiene, using a protected secondary amine functional lithium initiator, followed by reaction with a | |
| # sec-amine functional electrophile and then hydrogenation. The polymer butylene content is preferably in the range of 30-70%, but the range could be 10-90% of butylene content in the microstructure. The polymer has an amine functionality of about 1.9. | |

PART A. The DSA-PEB-50 di-sec-amine functional polyolefin and EPON 828 are added to a suitable reaction vessel, under a nitrogen atmosphere, with stirring, and the mixture is gradually heated to 110° C. The reaction mixture is maintained at this temperature for 2 hours.

PART B. In a separate reaction vessel under a nitrogen atmosphere, the Bisphenol A is heated above its melting point to 1650° C. While stirring, the advancement catalyst, ethyl triphenyl phosphonium iodide, is added to the molten Bisphenol A and mixed until a uniform mixture is obtained.

After the mixture of PART A has reacted for 2 hours, the Bisphenol A/catalyst mixture from PART B is slowly added to the reaction vessel of PART A. The mixture is allowed to exotherm to 1600° C., and reacted at this temperature for an additional 1.5 hours. The resultant chain-extended polyolefin epoxy adduct has an epoxide equivalent weight of about 800.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An adduct of an epoxy resin and an amine terminated polyolefin having the formula: 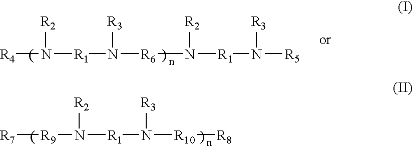
wherein:
R₁ is a polyolefin;
R₂ and R₃ are independently H or substituted or unsubstituted C1-C25 alkyl;
R₄ and R₅ are independently H or substituted or unsubstituted C1-C25 alkyl;
R₆ is a hydroxy containing moiety formed by the reaction of an epoxide with a primary or secondary amine-containing compound R₂—NH—R₁—NH—R₃ thereby opening the epoxide rings;
R₇ and R₈ are independently epoxide containing moieties;
R₉ and R₁₀ are independently hydroxy containing moieties formed by the reaction of an epoxide with a primary or secondary amine-containing compound R₂—NH—R₁—NH—R₃ thereby opening the epoxide ring; and
n is a number from 1 to 10.

2. The adduct according to claim 1, wherein n is 1 to 5.

3. The adduct according to claim 1, wherein R₁ is derived from an amine terminated polyolefin having a molecular weight of from about 1000 to about 200,000.

4. The adduct according to claim 3, wherein R₁ is derived from an amine terminated polyolefin having a molecular weight of from about 1500 to about 5000.

5. The adduct according to claim 1, wherein R₁ is derived from an amine terminated polyolefin in which at least about 70% of the unsaturated carbon-carbon double bonds are hydrogenated.

6. The adduct according to claim 1, wherein R₁ is a hydrogenated polybutadiene, a hydrogenated polyisoprene, or a hydrogenated copolymer of butadiene and isoprene.

7. The adduct according to claim 1, wherein R₁ is derived from an amine terminated polyolefin having a functionality of about 1.5 to about 2.0 amine groups per chain.

8. The adduct according to claim 1, wherein R₄ and R₅ are both hydrogen.

9. The adduct according to claim 8, wherein R₂ and R₃ are both hydrogen.

10. The adduct according to claim 1 having the formula I, wherein R₆ is formed by the reaction of a diepoxide with a secondary amine-containing compound R₂—NH—R₁—NH—R₃, the diepoxide selected from the group consisting of aromatic diepoxide resins and cycloaliphatic diepoxide resins.

11. The adduct according to claim 1 having the formula I, wherein R₆ is formed by the reaction of a diepoxide with a secondary amine-containing compound R₂—NH—R₁—NH—R₃, the diepoxide selected from the group consisting of the diglycidyl ether of bisphenol A; the diglycidyl ether of bisphenol F; the diglycidyl ether of resorcinol; the difunctional novalac of Bisphenol F; 2,2-bis-(4-glycidyloxycyclohexyl)propane; bis(3,4-epoxy-6-methylcyclohexyl)adipate; 3,4,-epoxycyclohexylmethyl-3,4-epoxy-cyclohexane-carboxylate; vinyl cyclohexane dioxide, 4-(1,2-epoxyethyl)-1,2-epoxycyclohexane, 1,2-8,9-diepoxy-p-menthane, 2,2-bis(3,4-epoxycyclohexyl)propane, 1,2-5,6-diepoxy-4,7-hexahydromethaneoindane, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, 3,4-epoxy-6-methylcyclohexylmethyl-4-epoxy-6-methylcyclohexane carboxylate, 2-(3,4-epoxy)cyclohexyl-5,5-spiro(3,4-epoxy)cyclohexane-m-dioxane, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, and o-(2,3-epoxy)cyclopentylphenyl-2,3-epoxypropyl ether.

12. The adduct of claim 1, wherein n is 1 or 2.

13. The adduct of claim 1, having the formula III: 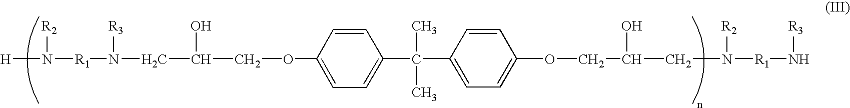
wherein R₁ is a polyolefin selected from the group consisting of hydrogenated polybutadienes, hydrogenated isoprenes, and hydrogenated copolymers of butadiene and isoprene; R₁ is derived from an amine terminated polyolefin having a molecular weight of from about 1000 to about 200,000; and n is 1 or 2.

14. The adduct of claim 1 having the formula II, wherein R₇-R₈ form a diepoxide and R₉-R₁₀ form a dihydroxy containing moiety formed by the reaction of said diepoxide with a secondary amine-containing compound R₂—NH—R₁—NH—R₃ thereby opening the epoxide rings, said diepoxide selected from the group consisting of aromatic diepoxide resins and cycloaliphatic diepoxide resins.

15. The adduct of claim 1 having the formula II, wherein R₇-R₈ form a diepoxide and R₉-R₁₀ form a dihydroxy containing moiety formed by the reaction of said diepoxide with a secondary amine-containing compound R₂—NH—R₁—NH—R₃ thereby opening the epoxide rings, said diepoxide selected from the group consisting of the diglycidyl ether of bisphenol A; the diglycidyl ether of bisphenol F; the diglycidyl ether of resorcinol; the difunctional novalac of Bisphenol F; 2,2-bis-(4-glycidyloxycyclohexyl)propane; bis(3,4-epoxy-6-methylcyclohexyl)adipate; 3,4,-epoxycyclohexylmethyl-3,4-epoxy-cyclohexane-carboxylate; vinyl cyclohexane dioxide, 4-(1,2-epoxyethyl)-1,2-epoxycyclohexane, 1,2-8,9-diepoxy-p-menthane, 2,2-bis(3,4-epoxycyclohexyl)propane, 1,2-5,6-diepoxy-4,7-hexahydromethaneoindane, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, 3,4-epoxy-6-methylcyclohexylmethyl-4-epoxy-6-methylcyclohexane carboxylate, 2-(3,4-epoxy)cyclohexyl-5,5-spiro(3,4-epoxy)cyclohexane-m-dioxane, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, and o-(2,3-epoxy)cyclopentylphenyl-2,3-epoxypropyl ether.

16. The adduct of claim 1, having the formula IV: 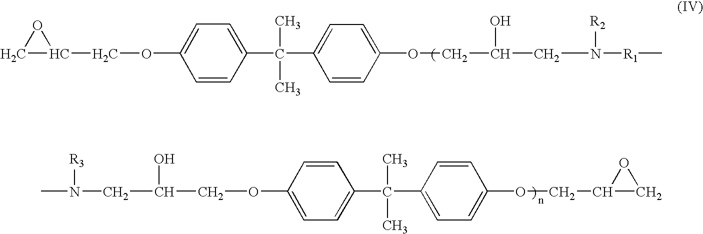
wherein R₁ is a polyolefin selected from the group consisting of hydrogenated polybutadienes, hydrogenated isoprenes, and hydrogenated copolymers of butadiene and isoprene; R₁ is derived from an amine terminated polyolefin having a molecular weight of from about 1000 to about 200,000; and n is 1 or 2.

17. The adduct of claim 1, wherein the adduct is the reaction product of an epoxy resin and an amine terminated polymer having the formula V:

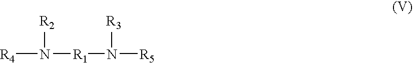

18. A method of making an adduct of an epoxy resin and an amine terminated polyolefin comprising reacting an epoxy resin having an epoxide functionality of at least about 2 with an amine terminated polyolefin of the formula 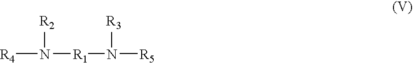
wherein:
R₁ is a polyolefin;
R₂ and R₃ are independently H or substituted or unsubstituted C1-C25 alkyl; and
R₄ and R₅ are independently H or substituted or unsubstituted C1-C25 alkyl.

19. The method according to claim 18, wherein said reacting step is conducted at a temperature of from about 0 to about 150° C. for at least about 0.5 hour.

20. The method according to claim 19, wherein said reacting step is conducted for at least about 0.5 to about 8 hours.

21. The method according to claim 18, wherein n moles of said epoxy resin is reacted with n+1 moles of said amine terminated polyolefin.

22. The method according to claim 18, wherein n+1 moles of said epoxy resin is reacted with n moles of said amine terminated polyolefin.

23. The method according to claim 21, wherein n is 1 or 2.

24. The method according to claim 22, wherein n is 1 or 2.

25. The method according to claim 18, wherein said epoxy resin is a diepoxide.

26. The method according to claim 18, wherein the amine groups of said amine terminated polyolefin are secondary amines.

27. The method according to claim 18, wherein said reacting step includes an excess of either said epoxy resin or said amine terminated polyolefin.

28. The method according to claim 27, wherein said excess is up to five times the stoichiometric amount of either said epoxy resin or said amine terminated polyolefin.

29. The method according to claim 18, wherein the amine terminated polyolefin has a molecular weight of from about 1000 to about 200,000.

30. The method according to claim 29, wherein the amine terminated polyolefin has a molecular weight of from about 1500 to about 5000.

31. The method according to claim 18, wherein at least about 70% of the unsaturated carbon-carbon double bonds of the amine terminated polyolefin are hydrogenated.

32. The method according to claim 18, wherein the amine terminated polyolefin is a hydrogenated polybutadiene, a hydrogenated polyisoprene, or hydrogenated copolymers of butadiene and isoprene.

33. The method according to claim 18, wherein the amine terminated polyolefin has a functionality of from about 1.5 to about 2.0 amine groups per chain.

34. The method according to claim 18, wherein the epoxy resin is selected from the group consisting of aromatic diepoxide resins and cycloaliphatic diepoxide resins.

35. The method according to claim 18, wherein the epoxy resin is selected from the group consisting of the diglycidyl ether of bisphenol A; the diglycidyl ether of bisphenol F; the diglycidyl ether of resorcinol; the difunctional novalac of Bisphenol F; 2,2-bis-(4-glycidyloxycyclohexyl)propane; bis(3,4-epoxy-6-methylcyclohexyl)adipate; 3,4,-epoxycyclohexylmethyl-3,4-epoxy-cyclohexane-carboxylate; vinyl cyclohexane dioxide, 4-(1,2-epoxyethyl)-1,2-epoxycyclohexane, 1,2-8,9-diepoxy-p-menthane, 2,2-bis(3,4-epoxycyclohexyl)propane, 1,2-5,6-diepoxy-4,7-hexahydromethaneoindane, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, 3,4-epoxy-6-methylcyclohexylmethyl-4-epoxy-6-methylcyclohexane carboxylate, 2-(3,4-epoxy)cyclohexyl-5,5-spiro(3,4-epoxy)cyclohexane-m-dioxane, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, and o-(2,3-epoxy)cyclopentylphenyl-2,3-epoxypropyl ether.

36. The method according to claim 18, wherein the epoxy resin is the diglycidyl ether of bisphenol A.

37. The method according to claim 18, wherein the epoxy resin has an epoxy equivalent weight of from 76 to 2000.

38. The method according to claim 18, wherein said reacting step is conducted in the presence of a solvent.

39. The method according to claim 38, wherein the solvent is acetone.

40. The method according to claim 18, wherein said reacting step is conducted at or around room temperature.

41. The method according to claim 18, wherein said reacting step is conducted in the presence of a catalyst.

42. The method according to claim 41, wherein the catalyst is selected from the group consisting of tertiary nitrogen bases, salts, complexes, quaternaries or similar phosphine compounds.

43. The method according to claim 18, wherein said adduct has the formula: 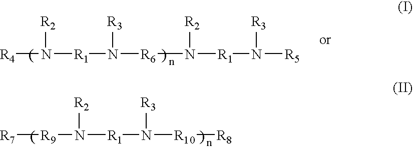
wherein:
R₁ is a polyolefin;
R₂ and R₃ are independently H or substituted or unsubstituted C1-C25 alkyl;
R₄ and R₅ are independently H or substituted or unsubstituted C1-C25 alkyl;
R₆ is a hydroxy containing moiety formed by the reaction of an epoxide with a primary or secondary amine-containing compound R₂—NH—R₁—NH—R₃ thereby opening the epoxide rings;
R₇ and R₈ are independently epoxide containing moieties;
R₉ and R₁₀ are independently hydroxy containing moieties formed by the reaction of an epoxide with a primary or secondary amine-containing compound R₂—NH—R₁—NH—R₃ thereby opening the epoxide ring; and
n is a number from 1 to 10.

44. A method of advancing an adduct of an epoxy resin and an amine terminated polyolefin comprising reacting the adduct of an epoxy resin and an amine terminated polyolefin of the formula 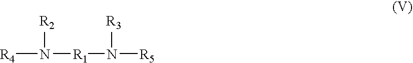
wherein:
R₁ is a polyolefin;
R₂ and R₃ are independently H or substituted or unsubstituted C1-C25 alkyl; and
R₄ and R₅ are independently H or substituted or unsubstituted C1-C25 alkyl,
with at least one polyfunctional compound selected from the group consisting of polyols, polyepoxides and mixtures thereof.

45. The method according to claim 44, wherein said polyfunctional compound is selected from the group consisting of the diglycidyl ether of bisphenol A; the diglycidyl ether of bisphenol F; the diglycidyl ether of resorcinol; the difunctional novalac of Bisphenol F; 2,2-bis-(4-glycidyloxycyclohexyl)propane; bis(3,4-epoxy-6-methylcyclohexyl)adipate; 3,4,-epoxycyclohexylmethyl-3,4-epoxy-cyclohexane-carboxylate; vinyl cyclohexane dioxide, 4-(1,2-epoxyethyl)-1,2-epoxycyclohexane, 1,2-8,9-diepoxy-p-menthane, 2,2-bis(3,4-epoxycyclohexyl)propane, 1,2-5,6-diepoxy-4,7-hexahydromethaneoindane, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, 3,4-epoxy-6-methylcyclohexylmethyl-4-epoxy-6-methylcyclohexane carboxylate, 2-(3,4-epoxy)cyclohexyl-5,5-spiro(3,4-epoxy)cyclohexane-m-dioxane, 1,2-epoxy-6-(2,3-epoxypropoxy)hexahydro-4,7-methanoindane, p-(2,3-epoxy)cyclopentylphenyl-2,3-epoxypropyl ether, 1-(2,3-epoxypropoxy)phenyl-5,6-epoxyhexahydro-4,7-methaneoindane, o-(2,3-epoxy)cyclopentylphenyl-2,3-epoxypropyl ether, 1,2-propylene glycol, 1,4 propylene glycol, 1,5-pentanediol, 1,2,6-hexanetriol, glycerol, neopentyl glycol, bis(4-hydroxycyclohexyl)-2,2-propane, Bisphenol A, Bisphenol F, resorcinol, 1,3,5-benzenetriol, 1-2-benzenediol, catechin, ethylene glycol, butylene glycol, 1,6-hexylene glycol, trimethylol propane, pentaerythritol, polyester polyols, polyether polyols, urethane polyols, acrylic polyols, 4,4′-dihydroxybenzophenone, bis(4-hydroxyphenyl)1,1-ethane, bis(4-hydroxyphenyl)1,1-isobutane, bis(4-hydroxyltertiarybutylphenyl-2,2-propane, bis(2-hydroxynaphthyl)methane, and 1,5-dihydroxynaphthylene.

46. The method according to claim 44, wherein said reacting step further comprises reacting at least one polycarboxylic acid with the adduct and the at least one polyfunctional compound.

47. The method according to claim 46, wherein the polycarboxylic acid is selected from the group consisting of oxalic acid, succinic acid, glutaric acid, terephthalic acid, 2,6-naphthalene dicarboxylic acid, dimerized linolenic acid, adipic acid, 3,3-dimethylpentanedioic acid, isophthalic acid, phthalic acid, phenylenediethanoic acid, pimelic acid, suberic acid, azelaic acid, sebacic acid, maleic acid, fumaric acid, tetrahydrophthalic acid, hexahydrophthalic acid, and trimellitic acid.

48. The method according to claim 44, wherein the adduct has the formula: 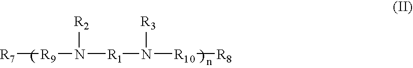
wherein:
R₁ is a polyolefin;
R₂ and R₃ are independently H or substituted or unsubstituted C1-C25 alkyl;
R₇ and R₈ are independently epoxide containing moieties;
R₉ and R₁₀ are independently hydroxy containing moieties formed by the reaction of an epoxide with a primary or secondary amine-containing compound R₂—NH—R₁—NH—R₃ thereby opening the epoxide ring; and
n is a number from 1 to 10.

49. The method according to claim 48, wherein n is from 1 to 5.

50. The method according to claim 49, wherein n is 1 or 2.

51. The method according to claim 44, wherein at least about 70% of the unsaturated carbon-carbon double bonds of the amine terminated polyolefin are hydrogenated

52. The method according to claim 44, wherein the adduct has formula IV below: 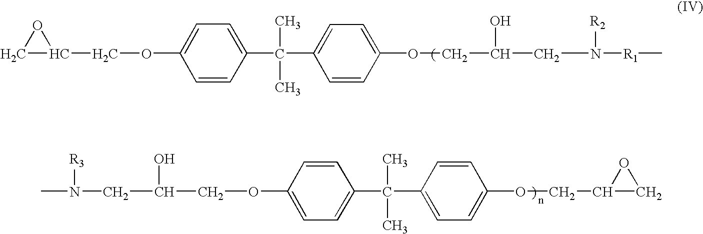
wherein R₁ is a polyolefin selected from the group consisting of hydrogenated polybutadienes, hydrogenated isoprenes, and hydrogenated copolymers of butadiene and isoprene; R₁ is derived from an amine terminated polyolefin having a molecular weight of from about 1000 to about 200,000; and n is 1 or 2.

53. An advanced adduct, comprising the reaction product of an epoxy resin and an amine terminated polyolefin, said reaction product having the formula 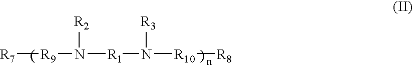
wherein:
R₁ is a polyolefin;
R₂ and R₃ are independently H or substituted or unsubstituted C1-C25 alkyl;
R₇ and R₈ are independently epoxide containing moieties;
R₉ and R₁₀ are independently hydroxy containing moieties formed by the reaction of an epoxide with a primary or secondary amine-containing compound R₂—NH—R₁—NH—R₃ thereby opening the epoxide ring; and
n is a number from 1 to 10,
with at least one polyfunctional compound selected from the group consisting of polyols, polyepoxides, and mixtures thereof.

54. The advanced adduct according to claim 53, having the formula 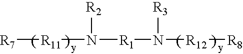
wherein:
R₁ is a polyolefin;
R₂ and R₃ are independently H or substituted or unsubstituted C1-C25 alkyl;
R₇ and R₈ are independently epoxide containing moieties;
R₁₁ and R₁₂ are independently hydroxy containing moieties formed by the reaction of the adduct of formula II with at least one polyfunctional compound selected from the group consisting of polyols, polyepoxides, and mixtures thereof; and
each y is independently 2 to 50.

55. The advanced adduct according to claim 54, wherein:
each R₁₁ and R₁₂ are 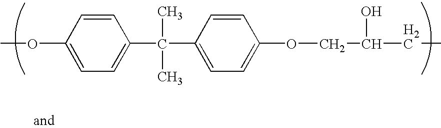
each R₇ and R₈ are

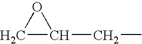

56. The reaction product of:
(1) an adduct formed by the reaction of
(a) an epoxy resin having an epoxide functionality of at least about 2; and
(b) an amine terminated polyolefin of the formula 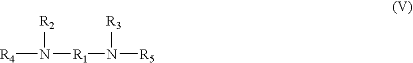
wherein:
R₁ is a polyolefin;
R₂ and R₃ are independently H or substituted or unsubstituted C1-C25 alkyl; and
R₄ and R₅ are independently H or substituted or unsubstituted C1-C25 alkyl; and
(2) at least one polyfunctional compound selected from the group consisting of polyols, polyepoxides, and mixtures thereof.

57. The reaction product of:
(a) an epoxy resin having an epoxide functionality of at least about 2; and
(b) an amine terminated polyolefin of the formula 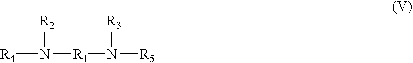
wherein:
R₁ is a polyolefin;
R₂ and R₃ are independently H or substituted or unsubstituted C1-C25 alkyl; and
R₄ and R₅ are independently H or substituted or unsubstituted C1-C25 alkyl.

58. A coating, adhesive or sealant, comprising the reaction product of claim 56.

59. A coating, adhesive or sealant, comprising the reaction product of claim 57.
